(19) United States
(12) Patent Application Publication
(10) Pub. No.: US 2017/0039335 A1
(43) Pub. Date: Feb. 9, 2017

(54) NEAREST NEIGHBOR PREDICTIONS FOR PROVIDING HEALTH INSIGHTS

(71) Applicant: Microsoft Technology Licensing, LLC, Redmond, WA (US)

(72) Inventors: Ansari Mohammed Ismail, Bellevue, WA (US); Hadas Bitran, Ramat Hasharon (IL); Royi Ronen, Tel Aviv (IL); Ohad Jassin, Tel Mond (IL); Elad Yom-Tov, Hoshaya (IL); Andrew Lindsay Dumovic, Seattle, WA (US); Haithem Albadawi, Redmond, WA (US); Farah Shariff, Kirkland, WA (US); Todd Holmdahl, Redmond, WA (US)

(73) Assignee: Microsoft Technology Licensing, LLC, Redmond, WA (US)

(21) Appl. No.: 14/957,409

(22) Filed: Dec. 2, 2015

Related U.S. Application Data
(60) Provisional application No. 62/202,116, filed on Aug. 6, 2015.

(51) Int. Cl. G06F 19/00

(52) U.S. Cl. CPC G06F 19/3406

(57) ABSTRACT

A network-accessible computer includes a network-communications interface, configured to receive health metrics of a user over a computer network. The network-accessible computer also includes a logic machine, which is configured to localize the user in a virtual space based on the health metrics, identify k nearest neighbors in the virtual space having k shortest Euclidean distances to the user, and generate a health insight comparing the user to the k nearest neighbors. The network-communications interface is further configured to send the health insight to a computing device associated with the user via the computer network.

### CROSS REFERENCE TO RELATED APPLICATIONS

This application claims priority to U.S. Provisional Patent Application No. 62/202,116, filed Aug. 6, 2015, the entirety of which is hereby incorporated herein by reference.

### BACKGROUND

Individuals can use health-monitoring devices to record various health metrics, including height, weight, resting heart rate, hours of sleep per night, steps taken per day, etc. This information may be uploaded to a physical-health service for viewing. The physical-health service can compare the information uploaded by one user to information uploaded by a population of other users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A network-accessible computer includes a network-communications interface, configured to receive health metrics of a user over a computer network. The network-accessible computer also includes a logic machine, which is configured to localize the user in a virtual space based on the health metrics, identify k nearest neighbors in the virtual space having k shortest Euclidean distances to the user within the virtual space, and generate a health insight comparing the user to the k nearest neighbors. The network-communications interface is further configured to send the health insight to a computing device associated with the user via the computer network.

### BRIEF DESCRIPTION OF THE DRAWINGS

FIG. 1 schematically shows an example health platform.

FIG. 2 schematically shows an example physical-health service.

FIG. 3 shows an example virtual space including a number of localized users.

FIG. 4 shows an example presentation of a health insight.

FIG. 5 shows an example method for generating health insights.

FIGS. 6A and 6B show aspects of an example wearable computing device.

FIG. 7 illustrates an example embodiment of a computing system.

### DETAILED DESCRIPTION

The present disclosure is directed to providing a user of a health platform with valuable health insights by comparing health metrics of the user to health metrics of a dynamically generated group of similar users. In some examples, one or more computing devices associated with a particular user may collect health metrics relating to the particular user, and upload this information to one or more physical-health services associated with a health platform. The physical-health services may dynamically determine one or more groups of users which are similar to the particular user according to uploaded health metrics. Health metrics collected from the particular user may be compared to health metrics collected from individuals within the dynamically determined groups, in order to generate meaningful health insights for the particular user. These health insights may be sent to one or more computing devices associated with the particular user. A health metric may comprise any information pertaining to a user's demographics, health, activities, lifestyle, preferences, etc. Nonlimiting examples of health metrics may include user age, height, weight, resting heart rate, blood pressure, amount exercised per day/week/month, gender, ethnic background, types of exercise performed, geographic location, musical preferences, computing device usage habits, etc.

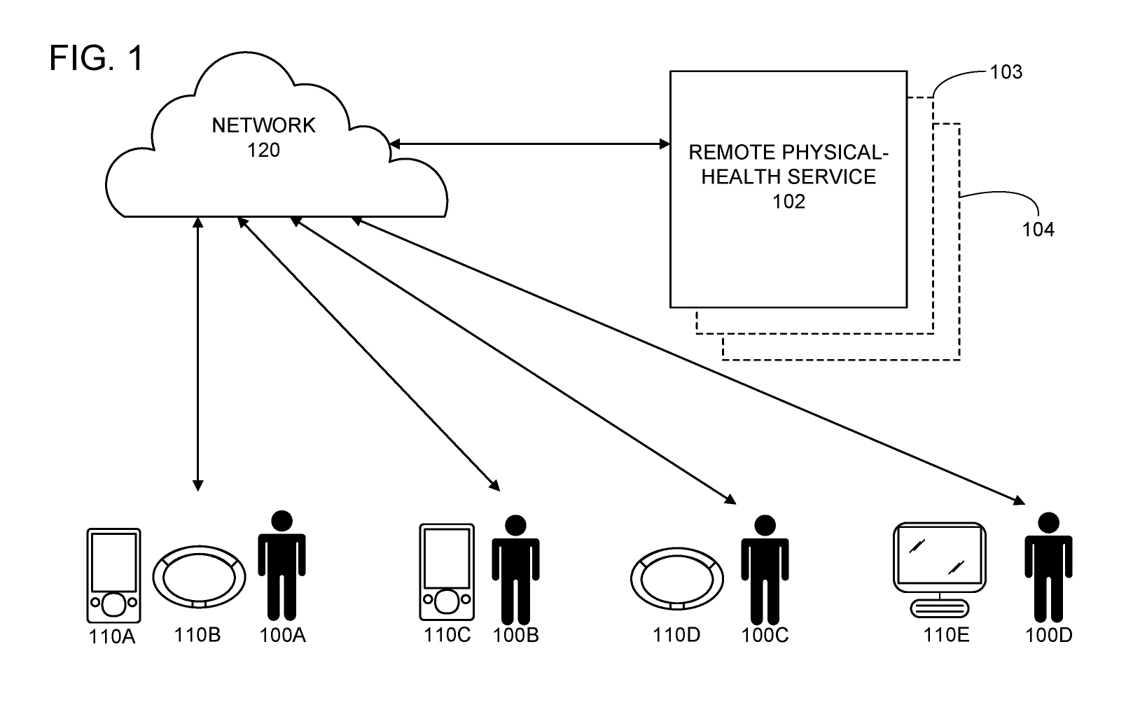

FIG. 1 schematically shows a plurality of different users 100 (e.g., User 100A, User 100B, User 100C and User 100D). Each user is using one or more computing devices 110 (e.g., smartphone 110A, fitness watch 110B, smartphone 110C, fitness watch 110D, and personal computer 110E). A variety of different types of computing devices may be used without departing from the scope of the present disclosure; smartphones, fitness watches, and personal computers are provided as nonlimiting examples. In general, each computing device 110 may be configured to monitor health metrics for a user, receive information pertaining to a user, communicate with one or more physical-health services, present health insights to a user, and/or perform other computing functions.

A computing device 110 optionally may include one or more sensors configured to collect information relating to one or more health metrics. As nonlimiting examples, a computing device 110 may include one or more of a microphone, visible-light sensor, ultraviolet sensor, ambient temperature sensor, contact sensor module, optical sensor module, barometer, accelerometer, gyroscope, magnetometer, global positioning system (GPS) receiver, as well as any other applicable sensors. Computing devices including such sensors may be referred to as health-monitoring computing devices.

The microphone may be configured to measure the ambient sound level or receive voice commands from the wearer. For example, a user may issue a voice command indicating that the computing device 110 should begin tracking health information. Input from the visible-light sensor, ultraviolet sensor, and ambient temperature sensor may be used to assess aspects of the wearer's environment—e.g., the temperature, overall lighting level, and whether the wearer is indoors or outdoors. Additionally or alternatively, the visible-light sensor, ultraviolet sensor, and ambient temperature sensor may be used individually or in conjunction with other sensors to determine when a user begins a new physical activity, and track aspects of the user's performance.

The accelerometer and gyroscope may furnish inertial and/or rotation rate data along three orthogonal axes as well as rotational data about the three axes, for a combined six degrees of freedom. This sensory data can be used to provide a pedometer/calorie-counting function, for example. Data from the accelerometer and gyroscope may be combined with geomagnetic data from the magnetometer to further define the inertial and rotational data in terms of geographic orientation. The wearable electronic device may include a global positioning system (GPS) receiver for determining the wearer's geographic location and/or velocity.

In the case where computing device 110 is a wearable health-monitoring computing device (e.g., fitness watches 110B and 110D), contact and optical sensor modules may be included. Such modules may be configured to directly contact a user's skin, and may measure a number of health metrics, including skin electrical resistance and/or capacitance, skin temperature, and whether or not the computing device 110 is currently being worn. Furthermore, the optical sensor module may be used to determine blood flow through the capillaries in the skin and thereby provide a measurement of the wearer's heart rate, blood oxygen level, blood glucose level, and/or other biomarkers with optical properties.

Sensors such as those listed above may collect physical-health information for a user of a health-monitoring computing device 110. For example, a computing device may determine the number of steps taken by a user during a period of time (e.g., a day, a week, a single workout session), the user's heart rate at rest and/or during exercise, the number of calories burned by a user during a period of time, a user's body temperature at rest and/or during exercise, the length of time per night a user spends sleeping and the number of times per night a user wakes up. In some examples, computing device 110 may be configured to interpret one or more sudden changes in speed or orientation as the beginning of a workout, and begin tracking health metrics accordingly. A GPS receiver, and/or other location sensor may be used in order to determine the distance traveled by a user during a period of time (e.g., a workout comprising: walking, running, cycling, and/or swimming). It will be appreciated that the examples provided above are not intended to limit the scope of the disclosure in any way. Computing device 110 may include any number of appropriate sensors, including sensors not explicitly described herein. Additionally, it will be appreciated that the sensors listed above, used either individually or cooperatively, may be used to track any number of health metrics while a user performs any number of activities.

In some examples, a computing device 110 may be able to receive health metrics from sources other than dedicated hardware sensors. For example, the computing device may include a user interface and/or other input modalities allowing a user to manually input health metrics. The computing device may additionally include a network-communications interface, allowing it to communicate with other computing devices over one or more wired, wireless local and/or wide area networks. As such, a computing device 110 which lacks suitable sensors for physical-health information collection may still obtain health metrics for a user. For example, a user may perform exercise while wearing a health-monitoring computing device (e.g., fitness watch 110B). Data collected by the wearable computing device may be copied or transferred to one or more other computing devices such as, for example, smartphone 110A or personal computing device 110E. This may allow a user to review health metrics from any one of several computing devices, even if the computing device was not present at the time the data was collected. Additionally or alternatively, a user may manually track health metrics for a workout or other period of activity, and manually enter such information into a computing device 110 via, for example, a user interface, a mouse and keyboard, or other suitable input modality. This may allow a user who does not have access to a computing device with appropriate hardware sensors to nonetheless benefit from physical-health information storage and analysis.

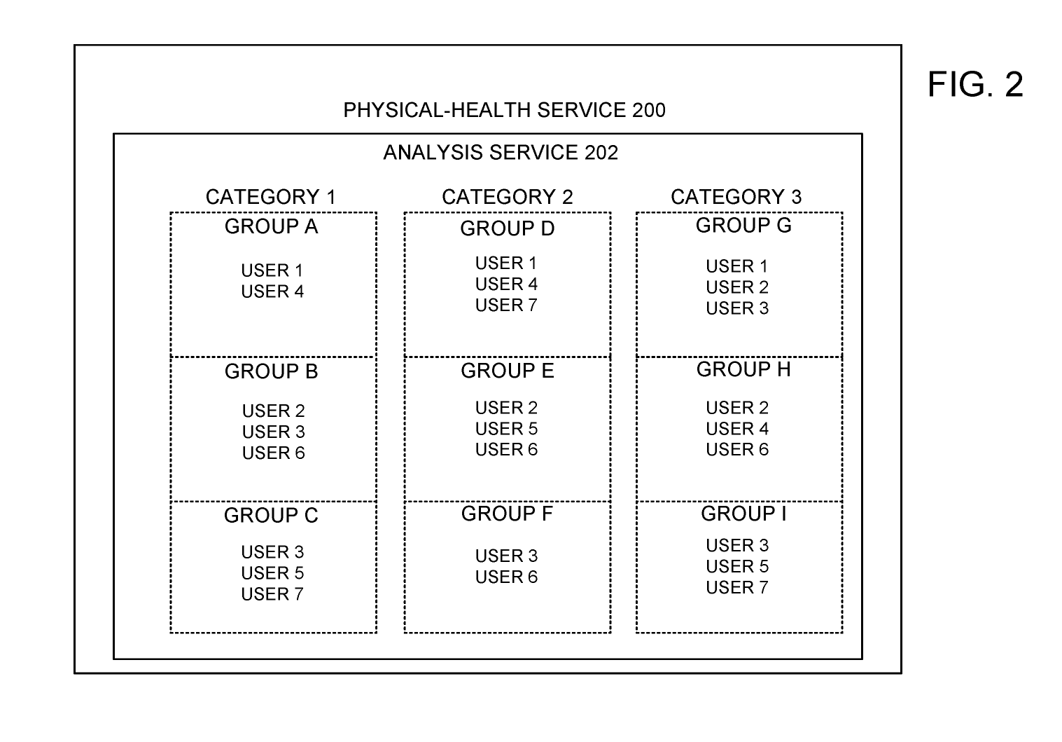

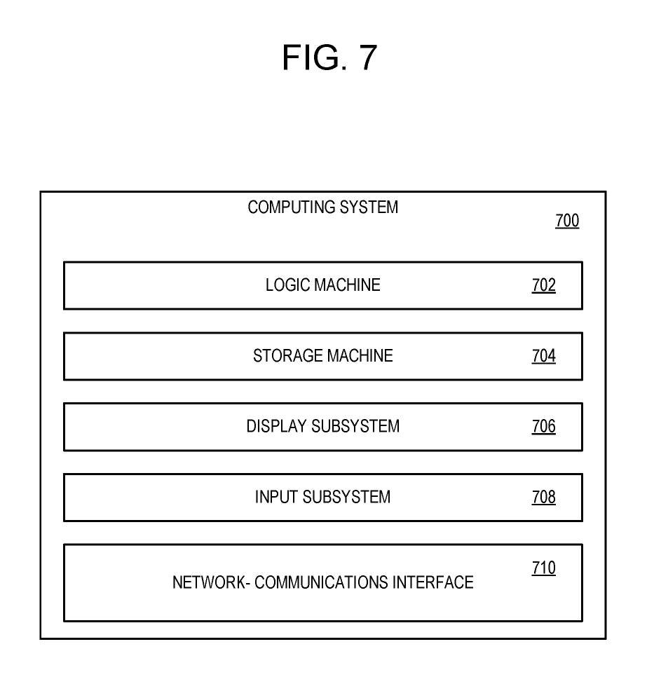

A computing device 110 may be further configured to communicate with one or more physical-health services such as, for example, remote physical-health services 102, 103, and 104. An example of a physical-health service usable with a computing device 110 is provided below with respect to FIG. 2. A physical-health service may be implemented as a network-accessible computer in accordance with FIG. 7. In different implementations, the physical-health service may take the form of one or more stand-alone computers communicatively accessible via computing devices 110. A computing device 110 may be configured to communicate with a physical-health service 102 over one or more wired, wireless local and/or wide area networks. A physical-health service may be locally located on the same user computing device that tracks and stores physical-health information for the particular user. In other examples, a physical-health service may be locally located on a companion user computing device. For example, a physical-health service may be located on a smartphone 110A that wirelessly communicates with a fitness watch 110B. In still other examples, a remote physical-health service may be located on one or more remote network-accessible computers, accessible via a computing network such as, for example, network 120.

During communication with a physical-health service, a computing device 110 may upload health metrics gathered and/or stored by the computing device 110 to the physical-health service for storage and/or processing. In this manner, a user may perform a physical activity while one or more computing devices (such as, for example, smartphone 110A or fitness watch 110B) measure health metrics pertaining to the physical activity. This information may then be uploaded to and stored by the physical-health service. The information may be accessed by the uploading computing device and/or one or more other authorized computing devices. For example, a user may regularly engage in physical activities while wearing a fitness watch 110B and still be able to access historical and/or statistical information regarding the user's physical activities from a personal computer 110E, after the personal computer retrieves the relevant information from the fitness watch and/or from the physical-health service.

A physical-health service may be configured to collect health metrics from a plurality of users 100, and store such health metrics for later access. A physical-health service may additionally be configured to perform one or more processing or analysis functions on the stored health metrics, for the purpose of providing each user of a health platform with insights relating to their physical health relative to the physical health of similar users. This health insight generation is described in further detail below.

A computing device 110 may in some examples be configured to present a user with information related to the user's physical health. Such information may be collected using one or more hardware sensors, manually input by a user, and/or received from a physical-health service. For example, a computing device 110 may be operable to provide a user with summaries of previous workouts performed, including the duration of the activity, the number of steps taken by the user, the user's maximum heart rate, the number of calories burned, and so on. A computing device 110 may additionally be operable to provide a user with graphs, charts or other summaries, for example indicating changes in a user's weight or body mass index (BMI) over time.

While providing a user with summaries of physical activities performed may be useful, it may in some cases be difficult for a user to understand the context of the information provided. For example, providing a user with information about the user's resting heart rate may not be helpful if the user does not know whether his/her resting heart rate is higher or lower than it should be. A computing device and/or physical-health service may be configured to determine average values for various health metrics for everyone in the general population, or all other users of the physical health service, and provide a user with this information. For example, a user may be notified that his resting heart rate is approximately average relative to all other people. However, this information may not be particularly helpful, as many of the people in the general population have different ages, heights, weights, genders, physical activity levels, or health metrics than the user. More valuable health insights may be provided by comparing health metrics of a user to health metrics of other users who are similar according to one or more health metrics, allowing a user to determine, for example, how his resting heart rate compares to a group of similar users.

Information received from a physical-health service may provide the user with one or more insights pertaining to the user's physical health relative to similar users of a health platform. For instance, a computing device 110 may notify a user that he gets more sleep and wakes up fewer times per night than similar users. A different user may be notified that her resting heart rate is somewhat higher than similar users. It will be appreciated that the health insights listed above are provided for the sake of example, and are not intended to limit the scope of the disclosure. Any of a user's health metrics may serve as the basis for a comparison to health metrics of a similar group of users.

FIG. 2 schematically shows a physical-health service 200 in accordance with the present disclosure. Physical health service 200 may include one or more computers or other logic machines. Physical-health service 200 may be usable by the plurality of users 100 and their associated computing devices 110, as described with respect to FIG. 1. Physical-health service 200 may be configured to communicate with one or more computing devices 110. During such communication, health metrics may be uploaded from the computing devices 110 to the physical-health service 200 and/or health metrics, insights and/or other data may be downloaded from the physical-health service 200 to one or more computing devices 110.

Physical-health service 200 may include a health information analysis service 202 configured to analyze health metrics stored by the physical-health service. Analysis service 202 may be configured to perform one or more processing or analysis steps on health metrics uploaded by the computing devices 110 and/or received from other sources. The processing and analysis may include generating one or more statistical summaries or health insights. For example, the analysis service 202 may dynamically generate one or more groups of similar users for each user of the plurality of users uploading health metrics to physical-health service 200, and compare health metrics for each user to users within the generated groups. Such analysis may determine, for example, that a given user gets less sleep per night than similar users.

Groups generated by a physical-health service may be organized together into categories, where a category includes all groups generated according to the same set of health metrics. In FIG. 2, analysis service 202 has dynamically generated three categories of groups, where each group includes users which are similar with respect to one or more health metrics. For example, Category 1 may include all groups organized according to a single health metric such as, for example, user age. Another category such as, for example, Category 2, may include all groups generated according to a subset of health metrics including, for example, height, weight, and age. Groups within category 3 may be generated according to all available health metrics. As described above, health metrics may include information pertaining to virtually any aspect of a user's lifestyle, including exercises the user enjoys, the user's geographic location, the user's musical preferences, etc. Seven users are provided for the sake of simplicity. In practice, hundreds, thousands, or even millions of users may upload health information.

Each category created by analysis service 202 may include a plurality of groups of similar users. For example, analysis service 202 may generate Groups A, B, and C within Category 1. Category 1 is shown as grouping seven different users. Seven users are provided for the sake of simplicity. In practice, hundreds, thousands, or even millions of users may be grouped according to any number of health metrics.

Group A may be generated according to health metrics corresponding to User 1, and may include User 1 and User 4 who are, for example, approximately the same age. Furthermore, Group B may be generated for User 2, and Group C may be generated for User 3, wherein the constituent members of Groups B and C are approximately the same age as Users 2 and 3, respectively. Similar groups may be generated within other categories. As described above, categories may include groups generated according to subsets of two or more health metrics. For example, Category 2 may take a subset of health metrics into account, while Category 3 may take all available health metrics into account. Further, the health metrics evaluated when generating a group may be weighted differently. For example, user age may be weighted more heavily than other health metrics when generating groups.

Using a variety of different health metrics to dynamically determine the groups of similar users, as in the case of Category 3, may improve the quality of the health insights generated for each user. For instance, while Group A includes users of approximately the same age, User 1 may be in much better physical condition than User 4, making insights generated from Group A relatively less useful. If, on the other hand, a user is grouped with other users of a similar height, weight, age, gender, activity level, lifestyle habits, etc., then more useful health insights may be generated.

As described above, once groups and health insights have been generated for a user, such information may be downloaded or otherwise accessed by one or more computing devices associated with the user. Such computing devices may automatically communicate with the physical-health service at predetermined intervals, and/or may request updated health insights from the physical-health service responsive to a user prompt. Furthermore, a physical-health service may automatically send updated health insights to one or more computing devices when new information becomes available. Further still, a computing device may automatically request health insights according to environmental context. For example, a computing device may request health insights from a physical-health service after the computing device determines that a user has finished a period of exercise.

The specific categories and groups described above are not intended to limit the scope of the disclosure. Analysis service 202 may generate any number of categories, directed to any number of health metrics. Each category may include any number of relevant groups. While FIG. 2 only shows three groups in each category, it will be appreciated that each category may include a group generated for each user, and that each group may include any number of users.

In some examples, the physical-health service may apply one or more processing and analysis steps to the health metrics to generate the one or more groups. For example, a physical-health service may utilize a dynamic bucketing mechanism which determines a user's k nearest statistical neighbors, or the users having above a statistical threshold similarity with a particular user, and establish the k nearest neighbors as a group, through which health insights can be generated for the user.

A variety of suitable methods may be used to find the k nearest neighbors of any particular user. In particular, a physical-health service may receive health metrics of a user via a computer network, as described above. Upon receipt of the health metrics, the physical-health service may localize the user in a virtual space, along with any other users who have also uploaded health metrics to the physical-health service.

The virtual space may include any suitable number of dimensions, and each dimension may correspond to a health metric. For example, if only one health metric is measured, the virtual space may be a virtual one-dimensional line. If the health metric is, for example, weight, then a relative position on the virtual line may indicate relative weight. If two or three health metrics are measured, then the virtual space may be a virtual two plane or three-dimensional space, respectively. For example, one dimension of a virtual three-dimensional space may correspond to weight, while another corresponds to height, and the third dimension corresponds to resting heart rate, or any other suitable health metric. In some embodiments, a virtual space may include dozens, hundreds, or even thousands of virtual dimensions, each corresponding to a different health metric.

When localizing users in the virtual space, the physical-health service may treat a value of each individual health metric as a coordinate in a dimension of the virtual space. Therefore, each user uploading health metrics to the physical-health service may be localized to a different position within the space, each position being defined by the specific values of the user's various health metrics. Further, the magnitude of the distance between any two users in the virtual space may correspond to a magnitude of the difference between those two users in the health metric associated with the dimension. For example, two users who have relatively similar weights may be localized to similar positions in a virtual dimension corresponding to weight. In contrast, two users with relatively dissimilar weights may be separated by a greater virtual distance in the dimension corresponding to weight.

Accordingly, a relative similarity between two users may be proportional to the length of a Euclidean distance between localized positions of the two users in the virtual space. Two users that are relatively similar in a number of health metrics will be localized to similar positions in a number of dimensions. Thus, a Euclidean distance between the two users will be relatively short. Alternately, two users that are relatively dissimilar in a number of health metrics will be localized to relatively disparate locations in a number of dimensions. Thus, a Euclidean distance between the two users will be relatively long. As such, users separated by relatively short Euclidean distances may be said to be similar to one another.

In some examples, a virtual space may be constructed using dimensions corresponding to health metrics which do not share a common scale. For example, one dimension may correspond to weight (measured in pounds, kilograms, etc.) while another corresponds to height (measured in inches, centimeters, etc.). Normal human weight may range from under one hundred pounds to several hundreds of pounds, while normal human height may range from under fifty inches to over eighty inches. As a result, if users were localized in a virtual space using their exact height and weight as coordinates, then users would be broadly distributed across a wide range of weights, and relatively narrowly distributed within a limited range of heights. In such an arrangement, differences in height between two users may have a smaller effect on the Euclidean distance between the two users than similar differences in weight. For example, two users of relatively similar weight and different height may be separated by a smaller Euclidean distance than two users of relatively similar height and different weight.

Accordingly, when constructing a virtual space, each dimension of the virtual space may be normalized to a shared scale. In particular, a range of each dimension may be adjusted, such that each dimension shares a common minimum value and a common maximum value. These values may be, for example, zero and one. In such an example, one or more processing operations may be performed such that all values of each health metric are converted to values between zero and one. As such, a user with an approximately average height may be localized on a height dimension at approximately 0.5, while a user with an approximately average weight is localized on a weight dimension at approximately 0.5. Users with health metric values higher or lower than most other users may be localized in corresponding dimensions at locations close to one or zero, respectively.

However, dimensions normalized as described above can be skewed when one or more users have health metric values significantly higher or lower than most other users. If a dimension including one or more such outlier values is normalized to share a common scale with other dimensions, then users with relatively normal health metric values in the dimension may end up clustered within a relatively small range, and separated from the outlier users by largely empty virtual space. Such clustering may reduce the impact of the dimension on any Euclidean distance calculations, as two users with significant differences in the relevant health metric will still be clustered into a relatively small range along the dimension. As such, when normalizing dimensions to share a common scale, the physical-health service may automatically identify any users which differ significantly from most other users in one or more health metrics, and not localize these outlier users in the virtual space. This may allow the physical-health service to generate more pertinent health insights for the majority of users who have largely typical health metrics.

Alternatively, a scale of each dimension in the virtual space may be adjusted, and a scale of one or more dimensions may be adjusted to a weighted scale, which is different from scales of other dimensions. For example, it may be determined that user age is a better indicator of overall user health and behavior than user height, weight, and/or other health metrics. Accordingly, in order to generate more pertinent health insights, a difference in age between two users should have a greater impact on the Euclidean distance between the two users than a difference in height. Therefore, a dimension associated with user age may be adjusted to a weighted scale, where two users with a certain age difference are separated by a greater distance than two users with a proportionally similar difference in height.

Further, one or more dimensions in the virtual space may be adjusted to have a scale which is not linear. For example, it may be desirable to associate one or more health metrics with dimensions that utilize logarithmic scales rather than linear scales. Additionally or alternatively, a scale of a dimension may be adjusted such that a given difference in a health metric equates to a greater virtual distance for values which are close to average than for values which are far from average. For example, a given difference in weight for two users of approximately average weight may correspond to a greater virtual distance than the same difference in weight for two users of far greater than average weight. Such a strategy may allow a physical-health service to maximize a resolution of a virtual space for most values, while minimizing the potential for outlier values to negatively impact Euclidean distance calculations. In general, any linear or non-linear scale may be used for any one or more dimensions.

Once a virtual space has been constructed, and users have been localized in the virtual space, the physical-health service may be configured to, for any given user, identify k nearest neighbors of the user, where k may be equal to virtually any number. The k nearest neighbors may comprise a group of k users whose localized positions are closer to the localized position of the user than all other localized users, in terms of Euclidean distance. In some examples, a Euclidean distance may be calculated between a particular user and all other users in the virtual space, and the k users with shortest Euclidean distances identified as the k nearest neighbors. In other examples, Euclidean distances may only be calculated between the particular user and a subset of other users in the virtual space, so as to conserve computational resources.

Alternatively, a physical-health service could accept as k nearest neighbors any users in a virtual space that fall within a threshold Euclidean distance of a particular user. For example, a common threshold Euclidean distance may be established for a virtual space. Finding the k nearest neighbors for any given user may then include identifying all users in the virtual space separated from the given user by less than the threshold Euclidean distance. This may then result in a value of k differing for each user, depending upon how many other users fall within the threshold Euclidean distance, where all of the k nearest neighbors identified for a given user share at least a threshold similarity with the given user.

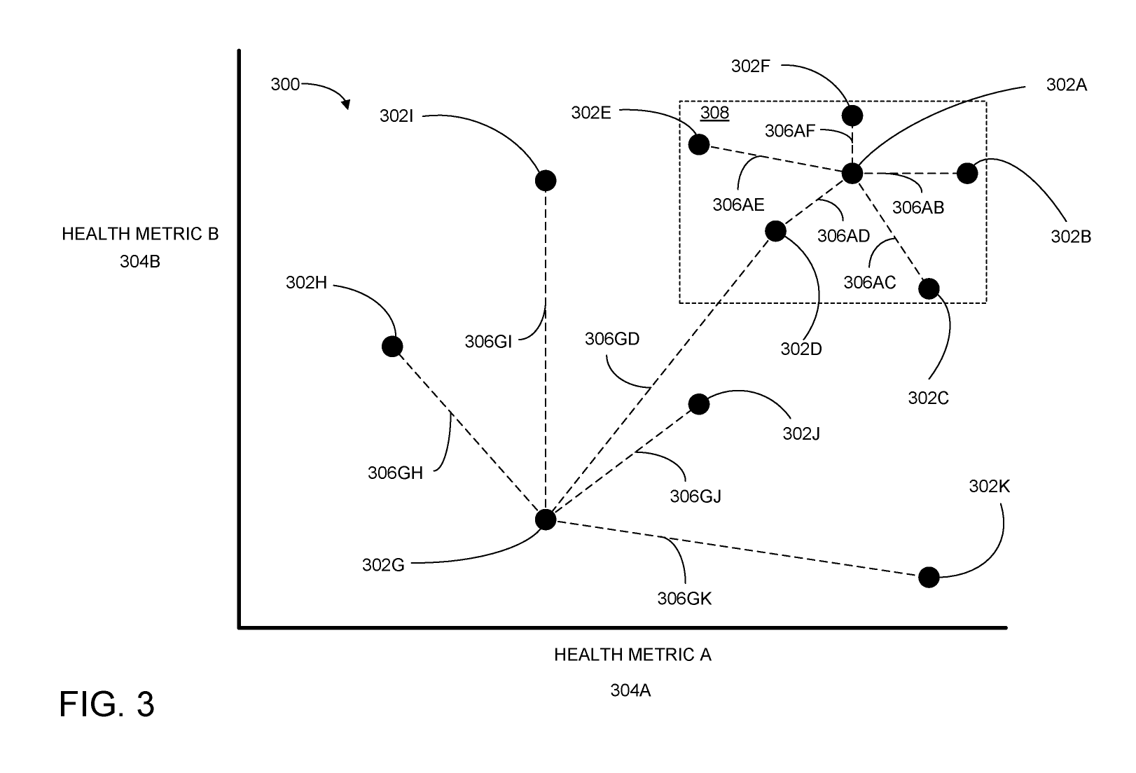

FIG. 3 illustrates the identification of the k nearest neighbors for a particular user, as described above. FIG. 3 shows a virtual space 300, including a number of localized users 302. Virtual space 300 includes two dimensions 304, where each dimension 304 corresponds to a different health metric. Health metrics A and B, corresponding to dimensions 304A and 304B, may represent virtually any aspect of a user's environment, demographic information, and physical health. Further, a virtual space may have any number of dimensions, corresponding to any number of health metrics, and may include any number of localized users. Dimensions 304 may be unaltered, where a position along each dimension corresponds to an exact value of a health metric. Alternatively, dimensions 304 may be normalized to share a common scale, one or more dimensions may be adjusted to have a weighted scale, and/or one or more dimensions may be given a non-linear scale.

Each user 302 is localized to a position within virtual space 300 corresponding to values of each of that user's health metrics associated with dimensions 304, each user's position within the virtual space being defined by a set of coordinates associated with the user's health metrics. For example, if health metrics A and B correspond to height and weight, then user 302A may be relatively tall and heavy, while user 302G is relatively short and light. Further, users are separated by Euclidean distances 306, where a length of each distance 306 is inversely proportional to relative similarity between two users. Though in FIG. 3, Euclidean distances 306 are only shown between some users 302, in some embodiments, a physical-health service may calculate Euclidean distances for all possible pairs of users in a virtual space.

For each user localized in virtual space 300, a physical-health service may identify k nearest neighbors of the user. For example, if k is equal to five, then a physical health service may identify the five users 302 that are closest to user 302A in the virtual space, according to calculated Euclidean distances. These five users are shown within box 308, which includes user 302A, as well as the k other users 302B, 302C, 302D, 302E, and 302F, which are most similar to user 302A relative to the two health metrics shown in FIG. 3.

The physical-health service may also identify k nearest neighbors for user 302G, as well as every other user 302 in virtual space 300. For example, Euclidean distances 306 are shown between user 302B and the k other users which are most similar to user 302B, assuming k is five. However, the physical-health service may not use the k nearest neighbors of user 302B, or any other user 302, to generate insights if it is determined that the user is significantly different from the identified k neighbors. This may be the case when, for example, the physical-health service attempts to identify k nearest neighbors for a user that occupies an outlier position on one or more dimensions 304.

In some examples, additional statistical validations may be performed in order to verify that the users identified as nearest neighbors are truly suitable for comparison. Such statistical validations may include determining that, for a given health metric: (1) a difference between a value of the given health metric for the user and a mean value calculated for the k nearest neighbors is less than a first threshold fraction of a standard deviation of the given health metric calculated for a population of users; and (2) a standard deviation of the given health metric calculated for the k nearest neighbors is less than a second threshold fraction of the standard deviation of the given health metric calculated for the population of users. The first and second threshold fractions may be any suitable values. For example, the first threshold fraction may be equal to ⅓, and the second threshold fraction is equal to ½. Using this example, if these conditions are satisfied, then the analysis service 202 may generate health insights by comparing the particular user to the nearest neighbors. If these conditions are not satisfied for one or more of the identified nearest neighbors, then those users may be excluded from the group generated for the particular user. For example, the above steps may be performed after identifying the k nearest neighbors of users 302A and 302G. The physical health service may determine that the k nearest neighbors of user 302A are suitable for comparison, while at least some of the k nearest neighbors of user 302G are not suitable for comparison. In this case, the physical-health service may generate insights for user 302G based on fewer than k nearest neighbors. Alternatively, the physical-health service may generate insights for user 302G based on all other users of the physical-health service, or refuse to generate insights for user 302G.

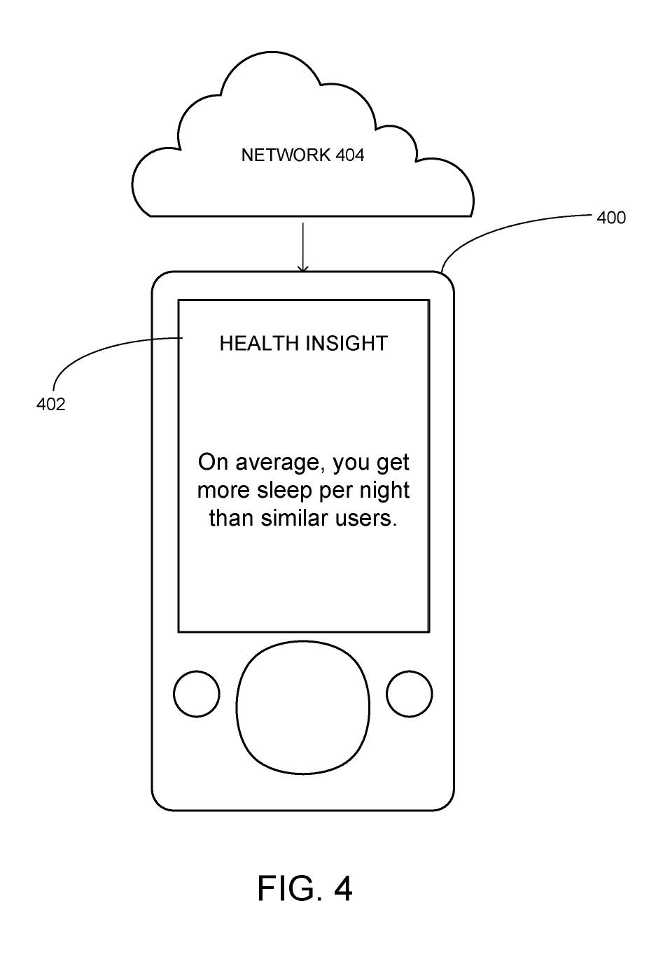

FIG. 4 shows a computing device 400 visually presenting a health insight 402. Computing device 400 presenting health insight 402 may be, for example, a computing device 110 of FIG. 1. Health insight 402 is not intended to limit the scope of the present disclosure. Rather, any number of health insights may be generated and presented to a user, as any number of health metrics may be compared between the user and any number of dynamically generated groups.

Alternate versions of insight 402 may be prepared for different types of computing devices. For example, insight 402 as shown in FIG. 4 is customized for presentation by a smartphone, though in alternate embodiments may be customized for presentation by a personal computer, such as computing device 110E and/or any other computing devices usable for viewing health insights. It will be appreciated that the same information may be accessible from other types of computing devices, and viewable in different formats depending upon the nature of the computing device used. Versions of health insight 402 presented by other types of computing devices may utilize different formatting, and may include different amounts of information or types of health metrics. For example, a version of health insight 402 may be customized for presentation by a personal computer, and may include more information than health insight 402 in order to accommodate the larger screen size. Further, in addition to or instead of visual health insight presentation, health insights may be presented audibly by, for example, a virtual assistant application. The insight may be generated based on health metrics collected by the computing device, received from one or more other computing devices, manually input by a user, retrieved from one or more supplementary physical-health information sources, or retrieved from a physical-health service. In the illustrated example, insight 402 has been retrieved from a computer network, network 404.

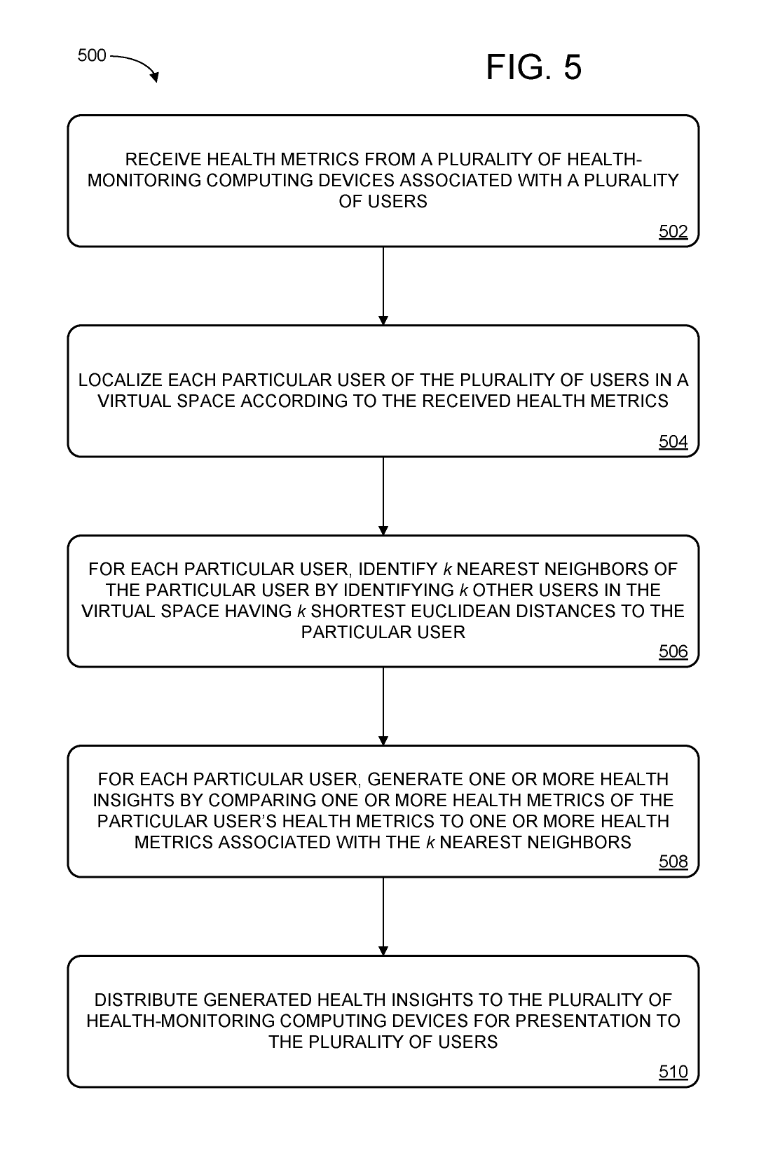

FIG. 5 shows a method 500 for generating and presenting insights. Method 500 starts at 502, which includes receiving health metrics from a plurality of health-monitoring computing devices associated with a plurality of users.

At 504, method 500 includes localizing each particular user of the plurality of users in a virtual space according to the received health metrics. As described above, the virtual space may include a plurality of dimensions, where each dimension is associated with a health metric.

At 506, method 500 includes, for each particular user, identifying k other users in the virtual space having k shortest Euclidean distances to the particular user. The virtual space may include any number of users. Further, k may be any suitable number.

At 508, method 500 includes generating one or more health insights by comparing one or more health metrics of a particular user to one or more health metrics associated with the k nearest neighbors. For example, a health insight may indicate to a user that he gets more sleep per night than similar users.

At 510, method 500 includes distributing generated health insights to the plurality of health-monitoring computing devices for presentation to the plurality of users. Health insights may be distributed and presented in any suitable manner, and may be customized depending on the nature of the health-monitoring computing device, as well as individual user preferences/requirements.

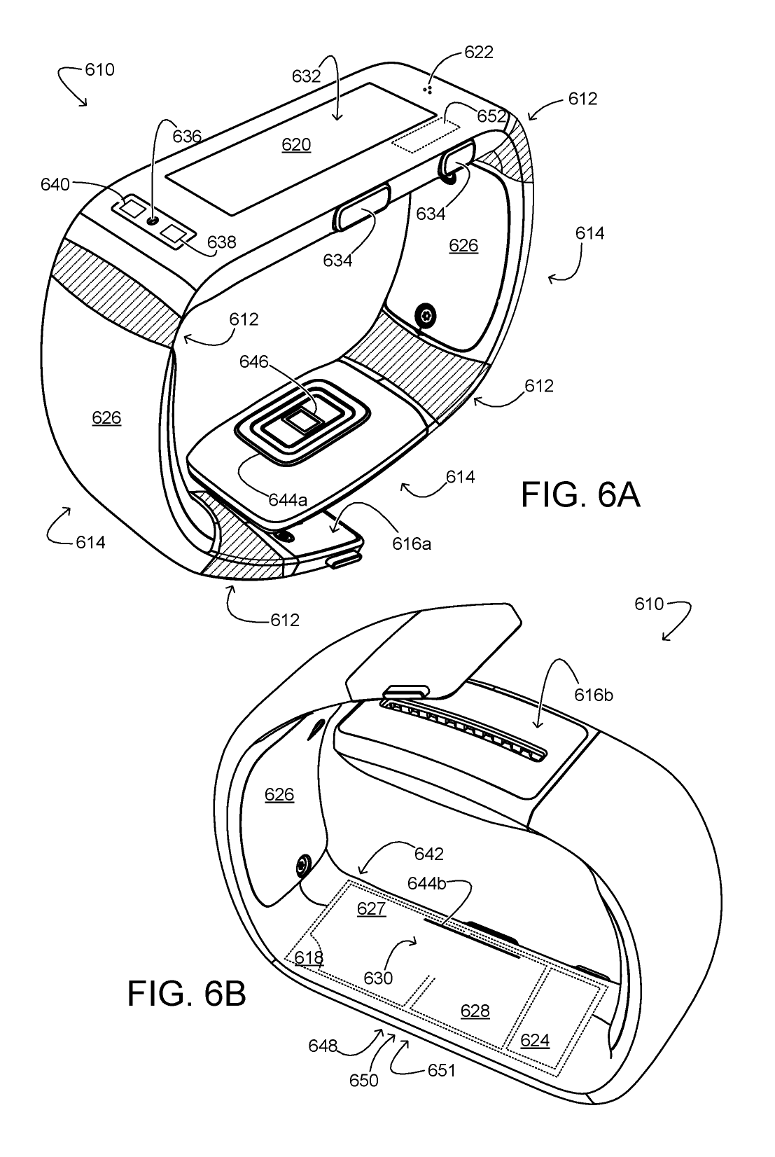

FIGS. 6A and 6B show aspects of an example computing device 110 in the form of a wearable electronic device 610. The illustrated device is band-shaped and may be worn around a wrist. Device 610 includes at least four flexion regions 612 linking less flexible regions 614. The flexion regions of device 610 may be elastomeric in some examples. Fastening componentry 616A and 616B is arranged at both ends of the device. The flexion regions and fastening componentry enable the device to be closed into a loop and to be worn on a user's wrist. In other implementations, wearable electronic devices of a more elongate band shape may be worn around the user's bicep, waist, chest, ankle, leg, head, or other body part. The device, for example, may take the form of eye glasses, a head band, an arm-band, an ankle band, a chest strap, or an implantable device to be implanted in tissue.

Wearable electronic device 610 includes various functional components integrated into regions 614. In particular, the electronic device includes a compute system 618, display 620, loudspeaker 622, communication suite 624, and various sensors. These components draw power from one or more energy-storage cells 626. A battery—e.g., a lithium ion battery—is one type of energy-storage cell suitable for this purpose. Examples of alternative energy-storage cells include super- and ultra-capacitors. In devices worn on the user's wrist, the energy-storage cells may be curved to fit the wrist, as shown in the drawings.

In general, energy-storage cells 626 may be replaceable and/or rechargeable. In some examples, recharge power may be provided through a universal serial bus (USB) port 630, which includes a magnetic latch to releasably secure a complementary USB connector. In other examples, the energy storage cells may be recharged by wireless inductive or ambient-light charging. In still other examples, the wearable electronic device may include electro-mechanical componentry to recharge the energy storage cells from the user's adventitious or purposeful body motion. For example, batteries or capacitors may be charged via an electromechanical generator integrated into device 610. The generator may be turned by a mechanical armature that turns while the user is moving and wearing device 610.

In wearable electronic device 610, compute system 618 is situated below display 620 and operatively coupled to the display, along with loudspeaker 622, communication suite 624, and the various sensors. The compute system includes a data-storage machine 627 to hold data and instructions, and a logic machine 628 to execute the instructions. Aspects of the compute system are described in further detail with reference to FIG. 7.

Display 620 may be any suitable type of display. In some configurations, a thin, low-power light emitting diode (LED) array or a liquid-crystal display (LCD) array may be used. An LCD array may be backlit in some implementations. In other implementations, a reflective LCD array (e.g., a liquid crystal on silicon, LCOS array) may be frontlit via ambient light. A curved display may also be used. Further, AMOLED displays or quantum dot displays may be used.

Communication suite 624 may include any appropriate wired or wireless communications componentry. In FIGS. 6A and 6B, the communications suite includes USB port 630, which may be used for exchanging data between wearable electronic device 610 and other computer systems, as well as providing recharge power. The communication suite may further include two-way Bluetooth, Wi-Fi, cellular, near-field communication and/or other radios. In some implementations, the communication suite may include an additional transceiver for optical, line-of-sight (e.g., infrared) communication.

In wearable electronic device 610, touch-screen sensor 632 is coupled to display 620 and configured to receive touch input from the user. The touch sensor may be resistive, capacitive, or optically based. Pushbutton sensors may be used to detect the state of push buttons 634, which may include rockers. Input from the pushbutton sensors may be used to enact a home-key or on-off feature, control audio volume, turn the microphone on or off, etc.

FIGS. 6A and 6B show various other sensors of wearable electronic device 610. Such sensors include microphone 636, visible-light sensor 638, ultraviolet sensor 640, and ambient temperature sensor 642. The microphone provides input to compute system 618 that may be used to measure the ambient sound level or receive voice commands from the wearer. Input from the visible-light sensor, ultraviolet sensor, and ambient temperature sensor may be used to assess aspects of the wearer's environment—i.e., the temperature, overall lighting level, and whether the wearer is indoors or outdoors.

FIGS. 6A and 6B show a pair of contact sensor modules 644A and 644B, which contact the wearer's skin when wearable electronic device 610 is worn. The contact sensor modules may include independent or cooperating sensor elements, to provide a plurality of sensory functions. For example, the contact sensor modules may provide an electrical resistance and/or capacitance sensory function, which measures the electrical resistance and/or capacitance of the wearer's skin. In the illustrated configuration, the separation between the two contact-sensor modules provides a relatively long electrical path length, for more accurate measurement of skin resistance. In some examples, a contact sensor module may also provide measurement of the wearer's skin temperature. Arranged inside contact sensor module 644B in the illustrated configuration is an optical sensor module 646. The optical sensor module may include an optical source configured to illuminate tissue of the user and a matched optical sensor to detect reflected illumination from the tissue of the user. Compute system 618 may use input from the contact sensor modules and/or the optical sensor module to assess whether or not the device is being worn, for instance. In some implementations, the input may be used to determine how tightly the wearable electronic device is being worn. The optical sensor module may be used to determine blood flow through the capillaries in the skin and thereby provide a measurement of the wearer's heart rate, blood oxygen level, blood glucose level, and/or other biomarkers with optical properties.

Wearable electronic device 610 may also include motion sensing componentry, such as an accelerometer 648, gyroscope 650, and magnetometer 651. The accelerometer and gyroscope may furnish inertial and/or rotation rate data along three orthogonal axes as well as rotational data about the three axes, for a combined six degrees of freedom. This sensory data can be used to provide a pedometer/calorie-counting function, for example. Data from the accelerometer and gyroscope may be combined with geomagnetic data from the magnetometer to further define the inertial and rotational data in terms of geographic orientation. The wearable electronic device may also include a global positioning system (GPS) receiver 652 for determining the wearer's geographic location and/or velocity. In some configurations, the antenna of the GPS receiver may be relatively flexible and extend into flexion regions 612.

Compute system 618, via the sensory functions described herein, is configured to acquire various forms of information about the wearer of wearable electronic device 610. Such information must be acquired and used with utmost respect for the wearer's privacy. Accordingly, the sensory functions may be enacted subject to opt-in participation of the wearer. In implementations where personal data is collected on the device and transmitted to a remote system for processing, that data may be anonymized. In other examples, personal data may be confined to the wearable electronic device, and only non-personal, summary data transmitted to the remote system.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. One or more computing devices 110 and/or network-accessible computing devices responsible for providing a physical-health service and/or generating health insights may be implemented as computing system 700. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, network-communications interface 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic machine 702 executing instructions held by storage machine 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, network-communications interface 710 may be configured to communicatively couple computing system 700 with one or more other computing devices. Network-communications interface 710 may include wired and/or wireless communication devices compatible with one or more different communication protocols. As non-limiting examples, the network-communications interface may be configured for communication via a wireless telephone network, or a wired or wireless local- or wide-area network. In some embodiments, the communication subsystem may allow computing system 700 to send and/or receive messages to and/or from other devices via a network such as the Internet.

In an example, a network-accessible computer comprises: a network-communications interface configured to receive health metrics of a user via a computer network; a logic machine configured to localize the user in a virtual space based on the health metrics of the user; the logic machine configured to identify k nearest neighbors in the virtual space having k shortest Euclidean distances to the user in the virtual space; the logic machine configured to generate a health insight comparing the user to the k nearest neighbors; and the network-communications interface configured to send the health insight to a computing device associated with the user via the computer network. In this example or any other example, the health metrics of the user include health metrics measured by one or more health sensors of one or more health-monitoring computing devices. In this example or any other example, the health metrics of the user include health metrics manually input via one or more input modalities of one or more computing devices. In this example or any other example, the virtual space includes a plurality of dimensions, and each dimension of the plurality of dimensions corresponds to a different health metric of the health metrics of the user. In this example or any other example, each dimension of the plurality of dimensions is normalized to a shared scale. In this example or any other example, a scale of one or more of the dimensions is adjusted to a weighted scale which is different from scales of other dimensions. In this example or any other example, a localized position of the user in the virtual space is defined by a set of coordinates, and each coordinate in the set of coordinates corresponds to a different health metric. In this example or any other example, the logic machine generates a health insight comparing the user to less than k nearest neighbors responsive to one or more of the k nearest neighbors having one or more health metrics significantly different from other users. In this example or any other example, the logic machine is configured to perform one or more statistical validation operations to confirm that the identified k nearest neighbors are suitable for comparison. In this example or any other example, the one or more statistical validation operations include: determining that, for a given health metric, a difference between a value of the given health metric for the user and a mean value calculated for the k nearest neighbors is less than a first threshold fraction of a standard deviation of the given health metric calculated for a population of users; and a standard deviation of the given health metric calculated for the k nearest neighbors is less than a second threshold fraction of the standard deviation of the given health metric calculated for the population of users. In this example or any other example, the first threshold fraction is equal to ⅓, and the second threshold fraction is equal to ½. In this example or any other example, the health insight indicates to the user how one or more health metrics of the user's health metrics compare to one or more health metrics of the k nearest neighbors.

In an example, a network-accessible computer comprises: a network-communications interface configured to receive health metrics of a user from a health-monitoring computing device via a computer network, the user's health metrics including a health metric measured by a health sensor of the health-monitoring computing device; a logic machine configured to localize the user in a virtual space based on the user's health metrics; the logic machine configured to identify k nearest neighbors in the virtual space having k shortest Euclidean distances to the user; the logic machine configured to generate a health insight comparing the user to the k nearest neighbors; and the network-communications interface configured to send the health insight to the health-monitoring computing device associated with the user via the computer network. In this example or any other example, the virtual space includes a plurality of dimensions, and each dimension of the plurality of dimensions corresponds to a different health metric of the health metrics of the user. In this example or any other example, each dimension of the plurality of dimensions is normalized to a shared scale. In this example or any other example, a scale of one or more of the dimensions is adjusted to a weighted scale which is different from scales of other dimensions. In this example or any other example, a localized position of the user in the virtual space is defined by a set of coordinates, and each coordinate in the set of coordinates corresponds to a different health metric. In this example or any other example, the logic machine is configured to perform one or more statistical validation operations to confirm that the identified k nearest neighbors are suitable for comparison, and the one or more statistical validation steps include: determining that, for a given health metric, a difference between a value of the given health metric for the user and a mean value calculated for the k nearest neighbors is less than a first threshold fraction of a standard deviation of the given health metric calculated for a population of users; and a standard deviation of the given health metric calculated for the k nearest neighbors is less than a second threshold fraction of the standard deviation of the given health metric calculated for the population of users.

In an example, a method for generating and presenting health insights comprises: receiving health metrics from a plurality of health-monitoring computing devices associated with a plurality of users; localizing each particular user of the plurality of users in a virtual space according to the received health metrics; for each particular user, identifying k nearest neighbors of the particular user by identifying k other users in the virtual space having k shortest Euclidean distances to the particular user; for each particular user, generating one or more health insights by comparing one or more health metrics of the particular user's health metrics to one or more health metrics associated with the k nearest neighbors; and distributing generated health insights to the plurality of health-monitoring computing devices for presentation to the plurality of users. In this example or any other example, the virtual space includes a plurality of dimensions, and each dimension of the plurality of dimensions corresponds to a different health metric of the health metrics; and localizing each particular user in the virtual space comprises identifying, for each user, a set of coordinates, and each coordinate in the set of coordinates corresponds to a different health metric.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A network-accessible computer, comprising:
a network-communications interface configured to receive health metrics of a user via a computer network;
a logic machine configured to localize the user in a virtual space based on the health metrics of the user;
the logic machine configured to identify k nearest neighbors in the virtual space having k shortest Euclidean distances to the user in the virtual space;
the logic machine configured to generate a health insight comparing the user to the k nearest neighbors; and
the network-communications interface configured to send the health insight to a computing device associated with the user via the computer network.

2. The network-accessible computer of claim 1, where the health metrics of the user include health metrics measured by one or more health sensors of one or more health-monitoring computing devices.

3. The network-accessible computer of claim 1, where the health metrics of the user include health metrics manually input via one or more input modalities of one or more computing devices.

4. The network-accessible computer of claim 1, where the virtual space includes a plurality of dimensions, and where each dimension of the plurality of dimensions corresponds to a different health metric of the health metrics of the user.

5. The network-accessible computer of claim 4, where each dimension of the plurality of dimensions is normalized to a shared scale.

6. The network-accessible computer of claim 4, where a scale of one or more of the dimensions is adjusted to a weighted scale which is different from scales of other dimensions.

7. The network-accessible computer of claim 4, wherein a localized position of the user in the virtual space is defined by a set of coordinates, and each coordinate in the set of coordinates corresponds to a different health metric.

8. The network accessible computer of claim 1, wherein the logic machine generates a health insight comparing the user to less than k nearest neighbors responsive to one or more of the k nearest neighbors having one or more health metrics significantly different from other users.

9. The network-accessible computer of claim 1, where the logic machine is configured to perform one or more statistical validation operations to confirm that the identified k nearest neighbors are suitable for comparison.

10. The network-accessible computer of claim 9, where the one or more statistical validation operations include:
determining that, for a given health metric, a difference between a value of the given health metric for the user and a mean value calculated for the k nearest neighbors is less than a first threshold fraction of a standard deviation of the given health metric calculated for a population of users; and
a standard deviation of the given health metric calculated for the k nearest neighbors is less than a second threshold fraction of the standard deviation of the given health metric calculated for the population of users.

11. The network-accessible computer of claim 10, where the first threshold fraction is equal to ⅓, and the second threshold fraction is equal to ½.

12. The network-accessible computer of claim 1, where the health insight indicates to the user how one or more health metrics of the user's health metrics compare to one or more health metrics of the k nearest neighbors.

13. A network-accessible computer, comprising:
a network-communications interface configured to receive health metrics of a user from a health-monitoring computing device via a computer network, the user's health metrics including a health metric measured by a health sensor of the health-monitoring computing device;
a logic machine configured to localize the user in a virtual space based on the user's health metrics;
the logic machine configured to identify k nearest neighbors in the virtual space having k shortest Euclidean distances to the user;
the logic machine configured to generate a health insight comparing the user to the k nearest neighbors; and
the network-communications interface configured to send the health insight to the health-monitoring computing device associated with the user via the computer network.

14. The network-accessible computer of claim 13, where the virtual space includes a plurality of dimensions, and where each dimension of the plurality of dimensions corresponds to a different health metric of the health metrics of the user.

15. The network-accessible computer of claim 14, where each dimension of the plurality of dimensions is normalized to a shared scale.

16. The network-accessible computer of claim 14, where a scale of one or more of the dimensions is adjusted to a weighted scale which is different from scales of other dimensions.

17. The network-accessible computer of claim 14, wherein a localized position of the user in the virtual space is defined by a set of coordinates, and each coordinate in the set of coordinates corresponds to a different health metric.

18. The network-accessible computer of claim 13, where the logic machine is configured to perform one or more statistical validation operations to confirm that the identified k nearest neighbors are suitable for comparison, and the one or more statistical validation steps include:
determining that, for a given health metric, a difference between a value of the given health metric for the user and a mean value calculated for the k nearest neighbors is less than a first threshold fraction of a standard deviation of the given health metric calculated for a population of users; and
a standard deviation of the given health metric calculated for the k nearest neighbors is less than a second threshold fraction of the standard deviation of the given health metric calculated for the population of users.

19. A method for generating and presenting health insights, the method comprising:
receiving health metrics from a plurality of health-monitoring computing devices associated with a plurality of users;
localizing each particular user of the plurality of users in a virtual space according to the received health metrics;
for each particular user, identifying k nearest neighbors of the particular user by identifying k other users in the virtual space having k shortest Euclidean distances to the particular user;
for each particular user, generating one or more health insights by comparing one or more health metrics of the particular user's health metrics to one or more health metrics associated with the k nearest neighbors; and
distributing generated health insights to the plurality of health-monitoring computing devices for presentation to the plurality of users.

20. The method of claim 19, where the virtual space includes a plurality of dimensions, and where each dimension of the plurality of dimensions corresponds to a different health metric of the health metrics; and
wherein localizing each particular user in the virtual space comprises identifying, for each user, a set of coordinates, and each coordinate in the set of coordinates corresponds to a different health metric.
